(19) United States
(12) Patent Application Publication
(10) Pub. No.: US 2025/0008248 A1
(43) Pub. Date: Jan. 2, 2025

(54) OPTICAL COMMUNICATION SYSTEM, CONTROL APPARATUS AND OPTICAL COMMUNICATION METHOD

(71) Applicant: NIPPON TELEGRAPH AND TELEPHONE CORPORATION, Tokyo (JP)

(72) Inventors: Yasunari TANAKA, Musashino-shi (JP); Takuya KANAI, Musashino-shi (JP); Kazutaka HARA, Musashino-shi (JP); Yumiko SENOO, Musashino-shi (JP); Shin KANEKO, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/709,754

(22) PCT Filed: Nov. 16, 2021
(86) PCT No.: PCT/JP2021/042087

§ 371 Date: May 13, 2024

(51) Int. Cl. H04Q 11/00; H04L 41/12; H04L 43/0864

(52) U.S. Cl. CPC H04Q 11/0062; H04L 43/0864; H04L 41/12; H04Q 2011/0083

(57) ABSTRACT

An optical switch having a plurality of ports outputs an optical signal received from a first port that is one of the plurality of ports connected to an optical communication device from a second port that another one of the plurality of ports according to a transmission path of an optical signal. An optical branching part branches an optical signal which has been output from a second port in accordance with a branching ratio. A measurement part measures a round trip time by transmitting and receiving an optical signal to and from an optical communication device through an optical switch, and calculates a transmission distance of the optical signal on the basis of the measured round trip time. An instruction part instructs, the optical branching part, of the branching ratio determined on the basis of the calculated transmission distance.

### TECHNICAL FIELD

The present invention relates to an optical communication system, a control apparatus and an optical communication method.

### BACKGROUND ART

The International Telecommunication Union Telecommunication (ITU-T) Standardization sector G.989.2 recommendations define Point to Point (PtP) Wavelength Division Multiplexing (WDM)-Passive Optical Network (PON) (refer to, for example, NPL 1). In the PtP WDM-PON system, communication is performed using different optical wavelengths for each ONU in the upstream direction and the downstream direction. The upstream direction is the direction from the ONU to the OLT. The downstream direction is the direction from the OLT to the ONU.

As described in NPL 1, in the PtP WDM-PON system, it is stipulated that a management control signal called Auxiliary Management and Control Channel (AMCC) is used as a signal for management and control used between the OLT and ONU. An AMCC signal is a signal which is superimposed on a main signal and transmitted after information to be transmitted is modulated in a predetermined manner. When the AMCC signal is superimposed on the main signal and transmitted, the OLT and the ONU can transmit a signal for management and control within the wavelength band of the optical wavelength used for the main signal. That is to say, management and control are realized without using a dedicated optical wavelength band for management and control. A wavelength determination process in which upstream and downstream optical wavelengths are determined is performed using the AMCC signal.

FIG. 10 is a diagram showing a configuration example of a PtP WDM-PON system. FIG. 10 shows a configuration relating to superimposition of an AMCC signal. An OLT and an ONU include a management control part. The AMCC signals are superimposed in the optical stage and separated in the electrical stage. FIG. 11 shows an example of an optical signal transmitted from an ONU or an OLT. The transmitted optical signal is the main signal on which the management control signal is superimposed. When the management control signal is superimposed on the optical signal, intensity modulation is added to the envelope of the main signal as shown in FIG. 11. The main signal is a high-speed signal with a data rate on the order of gigabits per second (Gb/s). On the other hand, the management control signal is expected to be a low-speed signal with a data rate on the order of kilobits per second (kb/s) (for example, NPL 2).

On the other hand, the All-Photonics Network (APN) is an innovative network based on photonics technology. In the APN, optical nodes relay optical backbone networks and optical access networks to provide end-to-end optical paths for each service. For example, the optical node is assumed to be an optical Switch (SW) or the like.

FIG. 12 is a diagram showing a configuration of an optical communication system in APN (refer to, for example, NPL 3). The optical communication system shown in FIG. 12 has a user terminal 92, an optical GW (optical gateway) 93, and an APN controller 96. The two optical GWs 93 are described as optical GWs 93-1 and 93-2. Three user terminals 92 connected to an optical GW 93-n (n=1, 2) are respectively described as user terminals 92-n-1 to 92-n-3. The user terminal 92 includes an optical transceiver (TRx). The optical GW 93-n has an optical SW 94-n and a wavelength multiplexing/demultiplexing part 95-n. The optical GW 93-1 and the optical GW 93-2 are connected using an optical transmission line 97 via a wavelength multiplexing/demultiplexing part 95-1 and a wavelength multiplexing/demultiplexing part 95-2.

The optical SW 94-n outputs light input from a first port 941 from a second port 942 and outputs light input from a second port 942 from a first port 941. Each second port 942 of the optical SW 94-n is connected to the wavelength multiplexing/demultiplexing part 95-n, but may be connected to another second port 942. An Arrayed Waveguide Grating (AWG) is, for example, used for the wavelength multiplexing/demultiplexing part 95-n. The wavelength multiplexing/demultiplexing part 95-n multiplexes optical signals of a plurality of wavelengths input from each second port 942 of the optical SW 94-n and outputs the multiplexed signal to the optical transmission line 97. Also, the wavelength multiplexing/demultiplexing part 95-n receives an optical signal from the optical transmission line 97, demultiplexes the input optical signal, and outputs the demultiplexed signals to the optical SW 94-n.

It is possible to select the transmission path through which the optical signal is transmitted by setting the connection relationship between the first ports 941 and the second ports 942 of each of the optical SW 94-1 and the optical SW 94-2. The APN controller 96 determines the transmission/reception wavelength of each user terminal 92 and the port connection relationship between the first ports 941 and the second ports 942 of each of the optical SWs 94-1 and 94-2. The APN controller 96 instructs the user terminals 92 on transmission/reception wavelengths in accordance with these determinations and instructs the optical SW 94-1 and optical SW 94-2 on the port connection relationship. In FIG. 12, a user terminal 92-1-1 and a user terminal 92-1-2 communicate and a user terminal 92-1-3 and a user terminal 92-2-3 communicate. Different wavelengths are used for these communications.

### CITATION LIST

### Non Patent Literature

[NPL 1] “ITU-T G.989.2, 40-Gigabit-capable passive optical networks 2 (NG PON2): Physical media dependent (PMD) layer specification,” February 2019.
[NPL 2] Yuanqiu Luo, Hal Roberts, Klaus Grobe, Maurizio Valvo, Derek Nesset, Kota Asaka, Harald Rohde, Joe Smith, Jun Shan Wey, and Frank Effenberger, “Physical Layer Aspects of NG-PON2 Standards-Part 2: System Design and Technology Feasibility [Invited],” Journal of Optical Communications and Networking, Vol. 8, No. 1, pp. 43-52, January 2016.
[NPL 3] Takuya KANAI, Kazuaki HONDA, Yasunari TANAKA, Shin KANEKO, Kazuki HARA, Junichi KANI, and Tomoaki YOSHIDA, “Photonic Gateway for All-Photonics Network”, The Institute of Electronics, Information and Communication Engineers General Conference, Correspondence Lecture Proceedings 2, B-8-20, p. 141, March 2021.

### SUMMARY OF INVENTION

### Technical Problem

In the APN, management control information is superimposed on the main signal by superimposing the AMCC signal which is slower than the main signal. Therefore, in order for the APN controller to acquire the management control information from the user terminal, it is assumed that the AMCC signal is extracted in the middle of the transmission path between the user terminals. However, in many cases, the transmission distance from each user terminal to the optical GW is different. For this reason, if light is extracted from the transmission paths of different user terminals at the same branching ratio, there are cases in which the APN controller branches off extra light that exceeds the minimum photosensitivity at which the AMCC signal can be received. When extra light is branched off, the light energy used for transmitting the main signal to the end user becomes inefficient. For this reason, there is a possibility that the transmission distance of the main signal will not be able to be maximized. It is expected that the transmission distance of the main signal will be made longer by minimizing the power of the branched light within the range in which the APN controller can receive the AMCC signal.

For example, in the case of FIG. 12, the transmission distance from user terminal 92-1-1 to the optical GW 93-1 is longer than the transmission distance from the user terminal 92-1-3 to the optical GW 93-1. Splitters 98 are provided in the optical transmission lines between the optical SW 94-1 and the wavelength multiplexing/demultiplexing part 95-1. The splitter 98 which branches the optical signal transmitted by the user terminal 92-1-1 uses a branching ratio in which the APN controller 96 is able to receive the optical signal from the user terminal 92-1-1. This branching ratio is also applied to the splitter 98 which branches the optical signal transmitted by the user terminal 92-1-3. Thus, excess light is extracted from the optical signal transmitted by the user terminal 92-1-3, which may result in inefficiency in energy efficiency.

In view of the above circumstances, an object of the present invention is to provide an optical communication system, a control apparatus and an optical communication method capable of branching an optical signal having the power necessary for light reception while minimizing reduction in the power of an optical signal transmitted through a transmission path.

### Solution to Problem

An optical communication system according to an aspect of the present invention includes: an optical switch which has a plurality of ports and outputs an optical signal received from a first port that is one of the plurality of ports connected to an optical communication device from a second port that is another one of the plurality of ports according to a transmission path of the optical signal; an optical branching part which branches the optical signal which has been output from the second port in accordance with a branching ratio; a measurement part which measures a round trip time by transmitting and receiving an optical signal to and from the optical communication device through the optical switch and calculates a transmission distance of the optical signal on the basis of the measured round trip time; and an instruction part which instructs, the optical branching part, of a branching ratio determined on the basis of the calculated transmission distance.

An optical communication system according to an aspect of the present invention includes: an optical switch which has a plurality of ports and outputs an optical signal received from a first port that is one of the plurality of ports connected to an optical communication device from a second port that is another one of the plurality of ports according to a transmission path of the optical signal; an optical branching part which branches the optical signal which has been output from the second port in accordance with a branching ratio; a measurement part which measures an optical intensity of the branched optical signal; and an instruction part which instructs the optical branching part to change the branching ratio so that the measured optical intensity approaches a predetermined optical intensity.

A control apparatus according to an aspect of the present invention includes: a measurement part which measures a round trip time by transmitting and receiving optical signals to and from the optical communication device through an optical switch which has a plurality of ports and outputs an optical signal received from a first port that is one of the plurality of ports connected to an optical communication device from a second port that is another one of the plurality of ports according to the transmission path of the optical signal, and calculates a transmission distance of an optical signal on the basis of the measured round trip time; and an instruction part which instructs, an optical branching part which branches the optical signal which has been output from the second port in accordance with the branching ratio, of the branching ratio determined on the basis of the calculated transmission distance.

A control apparatus according to an aspect of the present invention includes: a measurement part which measures an optical intensity of an optical signal branched at an optical branching part which branches, in accordance with a branching ratio, an optical signal which has been output from a second port of an optical switch which has a plurality of ports and outputs an optical signal received from a first port that is one of the plurality of ports connected to an optical communication device from the second port that is another one of the plurality of ports according to a transmission path of the optical signal; and an instruction part which instructs the optical branching part to change the branching ratio so that the measured optical intensity approaches a predetermined optical intensity.

An optical communication method according to an aspect of the present invention includes: a switching step of outputting, by an optical switch having a plurality of ports, an optical signal received from a first port that is one of the plurality of ports connected to an optical communication device from a second port that is another one of the plurality of ports according to a transmission path of the optical signal; a branching step of branching, by an optical branching part, the optical signal which has been output from the second port in accordance with a branching ratio; a measuring step of measuring, by a measurement part, a round trip time by transmitting and receiving an optical signal to and from the optical communication device through the optical switch and calculating a transmission distance of an optical signal on the basis of the measured round trip time; and an instruction step of instructing, the optical branching part, of the branching ratio determined on the basis of the calculated transmission distance.

An optical communication method according to an aspect of the present invention includes: a switching step of outputting, by an optical switch having a plurality of ports, an optical signal received from a first port that is one of the plurality of ports connected to an optical communication device from a second port that is another one of the plurality of ports according to a transmission path of the optical signal; a branching step of branching, by an optical branching part, the optical signal which has been output from the second port in accordance with a branching ratio; a measuring step of measuring, by a measurement part, an optical intensity of the branched optical signal; and an instruction step of instructing, by an instruction part, the optical branching part to change the branching ratio so that the measured light intensity approaches a predetermined light intensity.

An optical communication method according to an aspect of the present invention includes: a measuring step in which measuring a round trip time by transmitting and receiving optical signals to and from the optical communication device through an optical switch which has a plurality of ports and outputs an optical signal received from a first port that is one of the plurality of ports connected to an optical communication device from a second port that is another one of the plurality of ports according to the transmission path of the optical signal, and a transmission distance of an optical signal is calculated on the basis of the measured round trip time; and an instruction step of instructing, an optical branching part which branches the optical signal which has been output from the second port in accordance with the branching ratio, of the branching ratio determined on the basis of the calculated transmission distance.

An optical communication method according to an aspect of the present invention includes: a measuring step in which measures an optical intensity of an optical signal branched at an optical branching part which branches, in accordance with a branching ratio, an optical signal which has been output from a second port of an optical switch which has a plurality of ports and outputs an optical signal received from a first port that is one of the plurality of ports connected to an optical communication device from the second port that is another one of the plurality of ports according to a transmission path of the optical signal is measured; and an instruction step of instructing the optical branching part to change the branching ratio so that the measured optical intensity approaches a predetermined optical intensity.

### Advantageous Effects of Invention

According to the present invention, it is possible to branch an optical signal having a power necessary for light reception while minimizing reduction in the power of the optical signal transmitted through the transmission path.

### BRIEF DESCRIPTION OF DRAWINGS

FIG. 1 is a diagram showing a configuration of an optical communication system according to a first embodiment of the present invention.

FIG. 2 is a diagram showing a configuration of a variable branching ratio coupler used as an optical branching switch according to the first embodiment.

FIG. 3 is a diagram showing a configuration of a planar lightwave circuit (PLC) used as an optical branching switch according to the first embodiment.

FIG. 4 is a diagram showing a configuration of an optical communication system according to a second embodiment.

FIG. 5 is a diagram showing a configuration of an optical communication system according to a third embodiment.

FIG. 6 is a diagram showing a configuration of an optical communication system according to a fourth embodiment.

FIG. 7 is a diagram showing a configuration of an optical communication system according to a fifth embodiment.

FIG. 8 is a diagram showing a configuration of an optical communication system according to a sixth embodiment.

FIG. 9 is a diagram showing a hardware configuration of a control apparatus according to the first to sixth embodiments.

FIG. 10 is a diagram showing a configuration of a PtP WDM-PON system in the related art.

FIG. 11 is a diagram showing an optical signal in the related art.

FIG. 12 is a diagram showing a configuration of an optical communication system in the related art.

### DESCRIPTION OF EMBODIMENTS

Embodiments of the present invention will be described in detail below with reference to the drawings. Note that the same constituent elements in a plurality of drawings will be denoted by the same reference and description thereof will be omitted.

This embodiment is applicable to, for example, an optical communication system which superimposes a management control signal of an AMCC signal on a high-speed main signal and transmits the superimposed signal. Such an optical communication system has a splitter for branching an optical signal on an optical transmission line for transmitting the optical signal between user terminals to extract the AMCC signal. The optical communication system of this embodiment makes the branching ratio of the optical signal in the splitter variable in accordance with the transmission distance between the user terminal and the optical GW. That is to say, the control apparatus of the optical communication system sets the branching ratio of the splitter to achieve the minimum light sensitivity at which the AMCC signal can be received. Thus, the deterioration of the power of the optical signal is suppressed as much as possible and the transmission distance of the main signal is maximized.

### First Embodiment

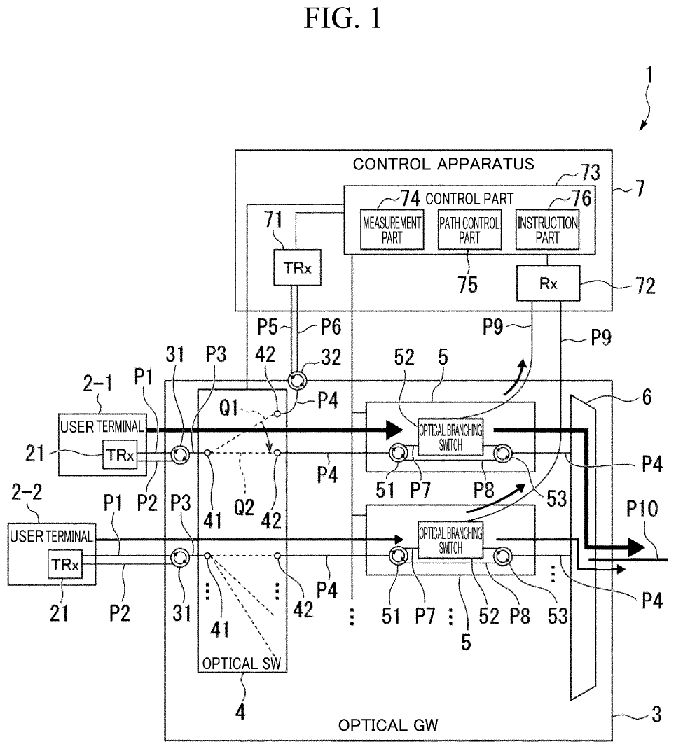

FIG. 1 is a diagram showing a configuration of an optical communication system 1 according to a first embodiment. The optical communication system 1 has user terminals 2, an optical GW 3, and a control apparatus 7. The number of user terminals 2 included in the optical communication system 1 is arbitrary. In FIG. 1, two user terminals 2 are described as user terminals 2-1 and 2-2. The optical GW 3 is connected to an optical network (not shown) via an optical transmission line P10. For example, an optical network is connected to a device with which the user terminal 2 communicates or an optical network is connected to a network which accommodates a device with which the user terminal 2 communicates. The direction from the user terminal 2 to the optical GW 3 is described as upstream and the direction from the optical GW 3 to the user terminal 2 is described as a downstream.

The user terminal 2 transmits and receives optical signals. A user terminal in the related art can be used as the user terminal 2. The user terminal 2 shown in FIG. 1 is a two-core optical transmission/reception device. The user terminal 2 is connected to the optical GW 3 via an optical transmission line P1 and an optical transmission line P2. The optical transmission line P1 and the optical transmission line P2 are, for example, two optical fibers in one two-core optical fiber cable. The user terminal 2 has an optical transceiver (TRx) 21.

The optical transmission/reception part 21 is a wavelength variable optical transmitter/receiver. For example, the optical transmission/reception part 21 is an optical transceiver which mutually converts an optical signal and an electrical signal. The user terminal 2 can select a wavelength according to a transmission/reception destination and set it in the optical transmission/reception part 21. For example, the user terminal 2 sets the wavelengths to be used for the upstream optical signal and the downstream optical signal in the optical transmission/reception part 21 in accordance with the instruction received from the control apparatus 7. The optical transmission/reception part 21 transmits/receives an optical signal in which a management control signal of an AMCC signal is superimposed on a main signal. Specifically, the optical transmission/reception part 21 converts a transmission signal in which a main signal of an electric signal and a management control signal of a lower frequency electric signal than the main signal are superimposed into an optical signal to generate an upstream optical signal and outputs the generated upstream optical signal to the optical transmission line P1. Furthermore, the optical transmission/reception part 21 receives a downstream optical signal from the optical transmission line P2 and converts the received downstream optical signal into an electrical signal. The optical transmission/reception part 21 separates the main signal and the management control signal of the AMCC signal from the signal converted into the electrical signal.

Note that the user terminal 2 may be a single-core optical transmission/reception device. In this case, the optical transmission/reception part 21 is connected to the optical GW 3 through one optical transmission line.

The optical GW 3 has a separation part 31, a separation part 32, an optical SW 4, an optical branching part 5, and a wavelength multiplexing/demultiplexing part 6. The optical GW 3 has one or more separation parts 31, one or more optical branching parts 5, and one or more wavelength multiplexing/demultiplexing parts 6.

The separation part 31 and the separation part 32 separate upstream optical signals and downstream optical signals. The separation part 31 and the separation part 32 can be implemented by, for example, a circulator or an upper/lower separation filter.

The separation part 31 is connected to the user terminal 2 using the optical transmission lines P1 and P2 and is connected to the optical SW 4 using the optical transmission line P3. The separation part 31 outputs the upstream optical signal input from the optical transmission line P1 to the optical transmission line P3 and outputs the downstream optical signal input from the optical transmission line P3 to the optical transmission line P2.

The separation part 32 is connected to the optical SW 4 using the optical transmission line P4 and is connected to the optical transmission/reception part (TRx) 71 of the control apparatus 7 using the optical transmission lines P5 and P6. The separation part 32 outputs the upstream optical signal input from the optical transmission line P4 to the optical transmission line P5 and outputs the downstream optical signal input from the optical transmission line P6 to the optical transmission line P4.

The optical SW 4 has a plurality of first ports 41 and a plurality of second ports 42. The optical SW 4 outputs an optical signal of a predetermined wavelength input from the first port 41 to the second port 42 according to the transmission path to the destination of the optical signal. Also, the optical SW 4 outputs an optical signal of a predetermined wavelength input from the second port 42 to the first port 41 according to the transmission path to the destination of the optical signal. The optical SW 4 can change the connection between the first ports 41 and the second ports 42. The connection relationship between the first ports 41 and the second ports 42 is referred to as a port connection relationship. For example, the optical SW 4 changes the port connection relationship in accordance with instructions from the control apparatus 7. The one or more first ports 41 are connected to the user terminal 2 via the optical transmission lines P1, P2, and P3 and the separation part 31. The one or more second ports 42 are connected to the optical transmission/reception part 71 of the control apparatus 7 via the optical transmission lines P4, P5, and P6 and the separation part 32 and other one or more second ports 42 are connected to the wavelength multiplexing/demultiplexing part 6 via an optical transmission line P4. A second port 42 connected to the optical transmission/reception part 71 of the control apparatus 7 is referred to as a second setting port 42.

The optical branching part 5 is provided on the optical transmission line P4 between the optical SW 4 and the wavelength multiplexing/demultiplexing part 6. There may be an optical transmission line P4 in which the optical branching part 5 is not provided. The optical branching part 5 has a separation part 51, an optical branching switch 52, and a separation part 53. The separation part 51 and the separation part 53 are connected using an optical transmission line P7 and an optical transmission line P8. The optical branching switch 52 is provided on the optical transmission line P7.

The separation part 51 separates the upstream optical signal and the downstream optical signal. The separation part 51 can be implemented by, for example, a circulator or an upper/lower separation filter. The separation part 51 receives the upstream optical signal output from the second port 42 of the optical SW 4 through the optical transmission line P4 and outputs the received upstream optical signal to the optical transmission line P7. Furthermore, the separation part 51 receives the downstream optical signal output from the separation part 53 via the optical transmission line P8 and outputs the received downstream optical signal to the optical transmission line P4.

The optical branching switch 52 branches the upstream optical signal transmitted through the optical transmission line P7 in accordance with the set branching ratio. The branching ratio is instructed from the control apparatus 7. Any optical branching device can be used for the optical branching switch 52 as long as the optical branching ratio can be varied. For example, the optical branching switch 52 may be an evanescent coupling type optical coupler, a fusion drawing type coupler whose length can be changed in a longitudinal direction, a planar lightwave circuit (PLC), or the like. The optical branching switch 52 outputs the branched optical signal to the control apparatus 7 via the optical transmission line P9. The upstream optical signal which is not branched using the optical branching switch 52 is transmitted through the optical transmission line P7 and input to the separation part 53.

The separation part 53 separates the upstream optical signal and the downstream optical signal. The separation part 53 can be realized using a circulator, an upper/lower separation filter, or the like, similarly to the separation part 51. The separation part 53 receives the upstream optical signal from the optical transmission line P7 and outputs the received upstream optical signal to the optical transmission line P4 between the separation part 53 and the wavelength multiplexing/demultiplexing part 6. Also, the separation part 53 receives the downstream optical signal output from the wavelength multiplexing/demultiplexing part 6 from the optical transmission line P4 and outputs the received downstream optical signal to the optical transmission line P8.

The wavelength multiplexing/demultiplexing part 6 has a plurality of first ports (not shown) and one second port (not shown). A plurality of first ports of the wavelength multiplexing/demultiplexing part 6 correspond to different wavelengths. The first ports of the wavelength multiplexing/demultiplexing part 6 are respectively connected to the different second ports 42 of the optical SW 4 via the optical transmission line P4. A second port of the wavelength multiplexing/demultiplexing part 6 is connected to the optical transmission line P10. The wavelength multiplexing/demultiplexing part 6 multiplexes upstream optical signals of different wavelengths input from the optical SW 4 through a plurality of first ports and outputs the multiplexed optical signal from the second port. Furthermore, the wavelength multiplexing/demultiplexing part 6 receives the downstream optical signal transmitted through the optical transmission line P10 from the second port and demultiplexes the received downstream optical signal into optical signals of different wavelengths. The wavelength multiplexing/demultiplexing part 6 outputs the demultiplexed downstream optical signals from different first ports. For example, the wavelength multiplexing/demultiplexing part 6 is an arrayed waveguide grating (AWG).

The control apparatus 7 is, for example, an APN controller. The control apparatus 7 includes an optical transmission/reception part (TRx) 71, an optical reception part (Rx) 72, and a control part 73. One or both of the optical transmission/reception part 71 and the optical reception part 72 may be provided outside the control apparatus 7 and may be provided in, for example, the optical GW 3. Furthermore, the control apparatus 7 may include a plurality of optical transmission/reception parts 71 and a plurality of optical reception parts 72, respectively. When the control apparatus 7 includes a plurality of optical transmission/reception parts 71, the optical transmission/reception parts 71 are connected to different second setting ports 42. When the control apparatus 7 includes the plurality of optical reception parts 72, the optical reception parts 72 is connected to different optical branching parts 5.

The optical transmission/reception parts 71 transmits and receives optical signals. The optical transmission/reception parts 71 may be a wavelength variable optical transmitter/receiver or a fixed wavelength optical transmitter/receiver. The functions of the optical transmission/reception part 71 are the same as those of the optical transmission/reception part 21 of the user terminal 2. The optical transmission/reception part 71 is connected to the second setting port 42 of the optical SW 4 via the optical transmission lines P4, P5, and P6 and the separation part 32. The optical transmission/reception part 71 outputs an optical signal addressed to the user terminal 2 to the optical SW 4. Furthermore, the optical transmission/reception part 71 receives an optical signal transmitted from the user terminal 2 and output from the second setting port 42 of the optical SW 4. The optical signal transmitted/received by the optical transmission/reception part 71 is a management control signal of the AMCC signal.

The optical reception part 72 receives an optical signal. The optical reception part 72 may be a wavelength variable optical receiver or a fixed wavelength optical receiver. An optical transceiver such as an optical transmitter/receiver may be used as the optical reception part 72. The optical reception part 72 receives the optical signal branched by the optical branching part 5 from the optical transmission line P9 and converts the received downstream optical signal into an electrical signal. The optical reception part 72 separates the management control signal of the AMCC signal from the signal which has been converted into the electrical signal.

The control part 73 includes a measurement part 74, a path control part 75, and an instruction part 76. The path control part 75 determines allocation resources such as transmission paths and transmission/reception wavelengths used by each user terminal 2. The path control part 75 instructs the user terminal 2 on the transmission/reception wavelength on the basis of the determined allocated resource. Furthermore, the path control part 75 instructs the optical SW 4 regarding the port connection relationship between the first port 41 and the second port 42 of the optical SW 4 on the basis of the determined allocated resources.

The measurement part 74 transmits an AMCC management control signal from the optical transmission/reception part 71 to the user terminal 2 and receives, from the user terminal 2, a response signal of the transmitted management control signal. The measurement part 74 measures the transmission distance between the control apparatus 7 and the user terminal 2 on the basis of the difference between the transmission time of the management control signal and the reception time of the response signal. The transmission distance between the optical SW 4 and the control apparatus 7 is very short compared to the transmission distance between the control apparatus 7 and the user terminal 2. For this reason, the measured transmission distance between the control apparatus 7 and the user terminal 2 is regarded as the transmission distance between the user terminal 2 and the optical SW 4. Also, since the transmission distance between the optical SW 4 and the optical branching part 5 is short, the transmission distance between the user terminal 2 and the optical SW 4 is regarded as the transmission distance between the user terminal 2 and the optical branching part 5. Note that, when the transmission distance between the optical SW 4 and the control apparatus 7 is known, the measurement part 74 may subtract the transmission distance between the optical SW 4 and the control apparatus 7 from the measured transmission distance between the control apparatus 7 and the user terminal 2 and calculate the transmission distance between the user terminal 2 and the optical SW 4. Thus, even when the transmission distance between the optical SW 4 and the control apparatus 7 is long, the transmission distance between the user terminal 2 and the optical SW 4 can be calculated more accurately. For example, an amount of attenuation of the light power when the light output from the optical SW 4 is received by the optical transmission/reception part 71 of the control apparatus 7 is measured in advance. The transmission distance between the optical SW 4 and the control apparatus 7 can be calculated on the basis of the measured attenuation.

The instruction part 76 calculates the branching ratio to be set in the optical branching switch 52 on the basis of the transmission distance measured by the measurement part 74. The instruction part 76 instructs the calculated branching ratio to the optical branching part 5 on the optical transmission line P4 which transmits the optical signal from the user terminal 2 whose transmission distance has been measured.

Subsequently, an example of the optical branching switch 52 will be described.

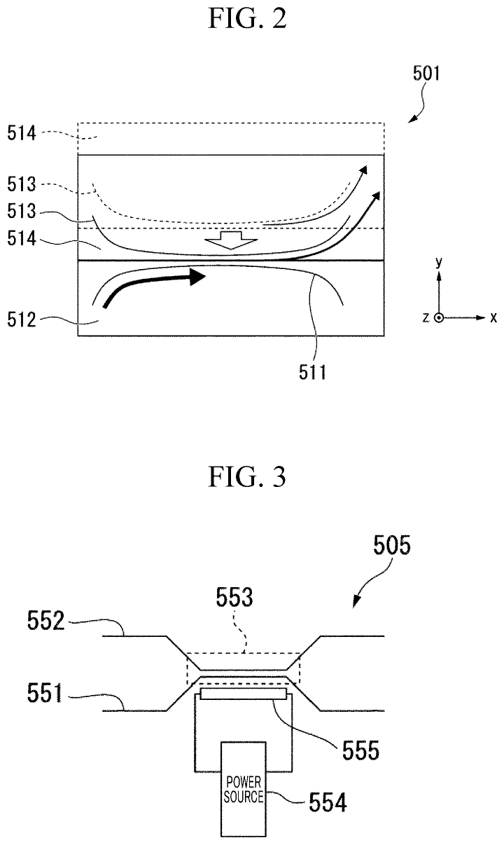

FIG. 2 is a diagram showing a configuration of a branching ratio variable coupler 501. The branching ratio variable coupler 501 is used as the optical branching switch 52. The branching ratio variable coupler 501 has a base 512 including a fiber 511 and a base 514 including a fiber 513. The fiber 511 is used as a part of the optical transmission line P7 or is connected to the optical transmission line P7 on the separation part 51 side and the optical transmission line P7 on the separation part 53 side. The fiber 511 is used as a part of the optical transmission line P9 or connected to the optical transmission line P9.

If the core of the fiber 511 and the core of the fiber 513 approach each other, the light propagating through the fiber 511 can be joined to the adjacent fiber 513. Thus, the light can be branched. The branching ratio can be adjusted by changing the distance between the core of the fiber 511 and the core of the fiber 513. The distance between the core of the fiber 511 and the core of the fiber 513 can be adjusted by moving the base 514 with the motor so that the distance corresponds to the branching ratio instructed by the control apparatus 7. In FIG. 2, an upper surface of a base 512 including the fiber 511 lies on an xz plane and optical signals are transmitted along an x-axis. Although the base 514 is moved in a y-axis direction to change the branching ratio in FIG. 2, the base 514 may be moved in a z-axis direction.

FIG. 3 is a diagram showing a configuration of a PLC 505. The PLC 505 can be used as the optical branching switch 52. The PLC 505 has waveguides 551 and 552, a power supply 554, and a thin film heater 555. The waveguide 551 is used as a part of the optical transmission line P7 or is connected to the optical transmission line P7 on the separation part 51 side and the optical transmission line P7 on the separation part 53 side. The waveguide 552 is used as a part of the optical transmission line P9 or connected to the optical transmission line P9.

A combiner 553 is formed in a part of the waveguide 551 and the waveguide 552. In the combiner 553, a part of the light transmitted through waveguide 551 is joined to the waveguide 552. The amount of heat generated by the thin film heater 555 is changed by changing the power supplied from the power supply 554 to the thin film heater 555 which heats the combiner 553 so that the branching ratio can be changed. The PLC 505 controls the power supply 554 so that the power supplied to the thin film heater 555 corresponds to the branching ratio instructed by the control apparatus 7.

Subsequently, the operation of the optical communication system 1 shown in FIG. 1 will be described. Here, a case in which the user terminal 2-1 communicates will be described as an example. A path Q1 between the first port 41 connected to the user terminal 2-1 and the second setting port 42 is set in the optical SW 4.

(Processing 1) If the user terminal 2-1 performs initialization, connection between the user terminal 2-1 and the control apparatus 7 is started. Thus, the optical SW 4 receives the optical signal transmitted by the optical transmission/reception part 21 of the user terminal 2-1 from the first port 41 and outputs the received optical signal from the second setting port 42. The optical transmission/reception part 71 of the control apparatus 7 receives the optical signal output from the second setting port 42 by the optical SW 4, acquires the management control signal of the AMCC signal from the received optical signal, and outputs it to the control part 73. Furthermore, the control part 73 transmits, from the optical transmission/reception part 71, an AMCC signal management control signal addressed to the user terminal 2-1. The optical SW 4 outputs the management control signal input from the second setting port 42 from the first port 41 to which the user terminal 2-1 is connected. The optical transmission/reception part 21 of the user terminal 2-1 receives the optical signal output from the first port 41 by the optical SW 4 and acquires the management control signal of the AMCC signal from the received optical signal.

(Processing 2) The measurement part 74 of the control apparatus 7 transmits a message M1 in which a time stamp indicating the current time t1 is set from the optical transmission/reception part 71 to measure the transmission distance between the user terminal 2-1 and the optical GW 3. The message M1 is a management control signal of AMCC signal. The optical SW 4 outputs the message M1 input from the second setting port 42 from the first port 41 to which the user terminal 2-1 is connected.

(Processing 3) The optical transmission/reception part 21 of the user terminal 2-1 receives the message M1. The user terminal 2-1 transmits, from the optical transmission/reception part 21, a message M2 in which the time stamp obtained from the message M1 is set. The message M2 is a management control signal of AMCC signal. The optical SW 4 outputs the message M2 input from the first port 41 from the second setting port 42. The optical transmission/reception part 71 of the control apparatus 7 outputs the received message M2 to the measurement part 74.

(Processing 4) The measurement part 74 of the control apparatus 7 calculates Round Trip Time (RTT) which is the frame round trip propagation time on the basis of time t1 indicated by the time stamp set in the message M2 and time t2 when the message M2 was received. The measurement part 74 multiplies the RTT by the refractive index [m/μs] in the fiber to calculate the transmission distance between the user terminal 2-1 and the optical SW 4. Alternatively, the measurement part 74 subtracts the transmission distance between the optical SW 4 and the control apparatus 7 from the transmission distance obtained by multiplying the RTT by the refractive index in the fiber, thereby obtaining the distance between the user terminal 2-1 and the optical SW 4.

(Processing 5) The path control part 75 of the control apparatus 7 determines the wavelength of upstream communication, the wavelength of downstream communication, and the transmission path to be assigned to the user terminal 2-1 in accordance with the communication destination of the user terminal 2-1. The path control part 75 transmits, from the optical transmission/reception part 71, a message M3 in which the wavelength to be assigned to the user terminal 2-1 is set. The message M3 is a management control signal of AMCC signal. The optical SW 4 outputs the message M3 input from the second setting port 42 from the first port 41 to which the user terminal 2-1 is connected. The user terminal 2-1 sets the wavelength assigned by the message M3 to the optical transmission/reception part 21. Furthermore, the path control part 75 of the control apparatus 7 sets the port connection relationship of the path Q2 to the optical SW 4. Thus, the path Q1 of the optical SW 4 is switched to the path Q2 between the first port 41 connected to the user terminal 2-1 and the second port 42 connected to the wavelength multiplexing/demultiplexing part 6.

(Processing 6) The instruction part 76 calculates the intensity of light when the light transmitted from the optical transmission/reception part 21 of the user terminal 2 reaches the optical GW 3 on the basis of the transmission distance calculated by the measurement part 74 in Processing 4. For example, the instruction part 76 stores in advance a relational expression representing the relationship between the transmission distance and the light intensity and substitutes the value of the transmission distance between the user terminal 2-1 and the optical GW 3 into the relational expression to determine the intensity. The relational expression may be a relational expression according to the characteristics of the optical transmission line P1 between the user terminal 2-1 and the optical GW 3. Alternatively, the relational expression may be a relational expression using the characteristics of the optical transmission line P1 between the user terminal 2-1 and the optical GW 3 as parameters in addition to the transmission distance. In this case, the instruction part 76 stores in advance a value representing the characteristics of the optical transmission line P1. The instruction part 76 calculates, from the light having the calculated intensity, a branching ratio for branching light having an intensity at which the optical reception part 72 can receive the AMCC signal with the minimum light receiving sensitivity. The instruction part 76 instructs the calculated branching ratio to the optical branching part 5 on the transmission path set in Processing 5. The optical branching part 5 controls the optical branching switch 52 to branch at the branching ratio instructed by the instruction part 76.

(Processing 7) The optical transmission/reception part 21 of the user terminal 2-1 converts the electrical signal in which the AMCC control signal is superimposed on the main signal into an optical signal with the wavelength set in Processing 5 and transmits the optical signal. The optical SW 4 outputs the optical signal input from the first port 41 from the second port 42 set using the path Q2. The optical branching switch 52 of the optical branching part 5 receives the optical signal output from the second port 42 and the optical signal branched from the input optical signal at the branching ratio set in Processing 6 is output to the optical reception part 72 of the control apparatus 7. The optical reception part 72 of the control apparatus 7 acquires the AMCC control signal from the received optical signal and outputs it to the control part 73. The optical signal which is not branched in the optical branching switch 52 of the optical branching part 5 is output to the optical transmission line P10 via the wavelength multiplexing/demultiplexing part 6.

Through the above-described processing, the optical communication system 1 adjusts the branching ratio of the optical branching switch 52 in accordance with the transmission distance between each user terminal 2 and the optical GW 3. Thus, since the branching ratio of the optical branching switch 52 can be optimized, the transmission distance of the main signal can be maximized.

### Second Embodiment

In the first embodiment, the control apparatus determines the branching ratio on the basis of the transmission distance between the optical GW and the user terminal. In this embodiment, the control apparatus determines the branching ratio on the basis of the received power of the light branched by the optical branching part. This embodiment will be described with a focus on differences from the first embodiment.

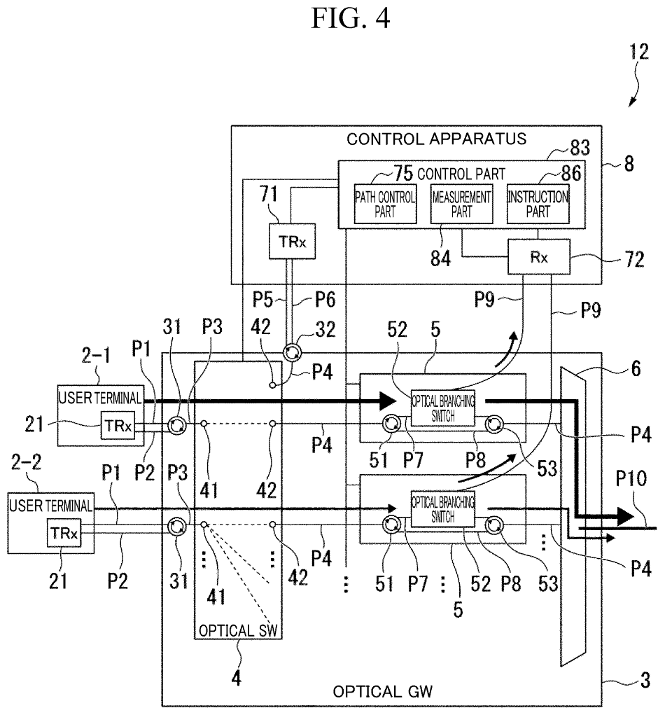

FIG. 4 is a diagram showing a configuration of an optical communication system 12 according to a second embodiment. Constituent elements in FIG. 4 that are the same as those of the optical communication system 1 according to the first embodiment shown in FIG. 1 will be denoted by the same reference numerals and description thereof will be omitted. The optical communication system 12 differs from the optical communication system 1 of the first embodiment in that it includes a control apparatus 8 instead of the control apparatus 7.

The control apparatus 8 includes an optical transmission/reception part 71, an optical reception part 72, and a control part 83. The control part 83 includes a path control part 75, a measurement part 84, and an instruction part 86. The measurement part 84 may be provided outside the control part 83 or may be provided outside the control apparatus 8.

The measurement part 84 is a power monitor. The measurement part 84 measures the reception power of the light received by the optical reception part 72 and outputs the measured reception power to the instruction part 86. The instruction part 86 changes the branching ratio of the optical branching part 5 on the basis of the reception power so that a reception power at the optical reception part 72 approaches the minimum light receiving sensitivity at which the optical reception part 72 can receive the AMCC signal. That is to say, when the received power is greater than the minimum photosensitivity, in order to reduce the power of the light branched to the optical reception part 72 side, the instruction part 86 instructs the optical branching part 5 to change the branching ratio by a predetermined change amount or by a change amount corresponding to the deviation of the received power from the minimum light receiving sensitivity. Furthermore, when the received power is smaller than the minimum photosensitivity, in order to increase the power of the light branched to the optical reception part 72 side, the instruction part 86 instructs the optical branching part 5 to change the branching ratio by a predetermined change amount or by a change amount corresponding to the deviation of the received power from the minimum light receiving sensitivity.

Furthermore, the instruction part 86 may change the branching ratio of the optical branching part 5 so that a reception power at the optical reception part 72 approaches a target range that is a predetermined light receiving sensitivity range in which the optical reception part 72 can receive the AMCC signal. The target range can be any range of photosensitivity of the minimum photosensitivity or more. When the received power is greater than the specified target range, in order to reduce the power of the light branched to the optical reception part 72 side, the instruction part 86 instructs the optical branching part 5 to change the branching ratio by a predetermined change amount or by a change amount according to the deviation of the received power from the target range. Furthermore, when the received power is less than the target range, in order to increase the power of the light branched to the optical reception part 72 side, the instruction part 86 instructs the optical branching part 5 to change the branching ratio by a predetermined change amount or by a change amount according to the deviation of the received power from the target range.

After instructing to change the branching ratio, the instruction part 86 receives, from the measurement part 84, the measured value of the reception power received by the optical reception part 72. Upon receiving feedback of the reception power, the instruction part 86 repeatedly performs the process of changing the branching ratio of the optical branching part 5 again so that the reception power approaches the minimum light receiving sensitivity or the target range. Note that, when changing the branching ratio so that the received power approaches the minimum photosensitivity, the instruction part 86 may not instruct to change the branching ratio when the deviation between the received power and the minimum photosensitivity is a predetermined value or more.

### Third Embodiment

In the first embodiment and the second embodiment, the wavelength multiplexing/demultiplexing part has a single core configuration. In this embodiment, the wavelength multiplexing/demultiplexing part has a two-core configuration. This embodiment will be described with a focus on differences from the first embodiment.

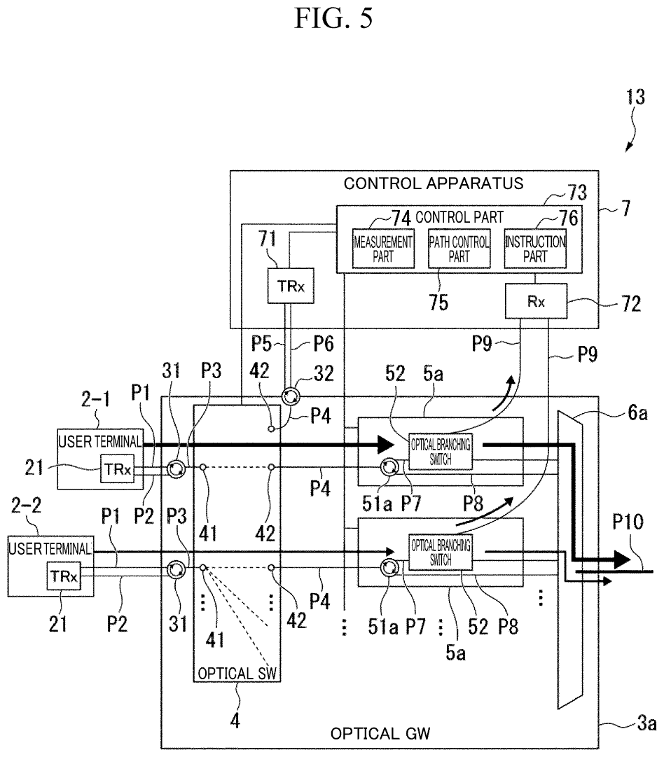

FIG. 5 is a diagram showing a configuration of an optical communication system 13 of the third embodiment. Constituent elements in FIG. 5 that are the same as those of the optical communication system 1 according to the first embodiment shown in FIG. 1 will be denoted by the same reference numerals and description thereof will be omitted. The optical communication system 13 differs from the optical communication system 1 of the first embodiment in that it includes an optical GW 3a instead of the optical GW 3. The optical GW 3a differs from the optical GW 3 of the first embodiment in that it includes an optical branching part 5a and a wavelength multiplexing/demultiplexing part 6a instead of the optical branching part 5 and the wavelength multiplexing/demultiplexing part 6.

The optical branching part 5a is connected to the optical SW 4 through an optical transmission line P4 and is connected to the wavelength multiplexing/demultiplexing part 6a through an optical transmission line P7 and an optical transmission line P8. The optical branching part 5a includes a separation part 51a and an optical branching switch 52. The separation part 51a receives the upstream optical signal output from the second port 42 of the optical SW 4 through the optical transmission line P4 and outputs the received upstream optical signal to the optical transmission line P7. Furthermore, the separation part 51a receives the downstream optical signal output from the optical transmission line P8 by the wavelength multiplexing/demultiplexing part 6a and outputs the input downstream optical signal to the optical transmission line P4.

A wavelength multiplexing/demultiplexing part 6a is a two-core AWG. A plurality of first ports of the wavelength multiplexing/demultiplexing part 6a are respectively connected to the optical transmission lines P7 or the optical transmission lines P8. The wavelength multiplexing/demultiplexing part 6a receives upstream optical signals of different wavelengths output by the optical SW 4 from a plurality of first ports connected to the optical transmission lines P7 and multiplexes the received optical signals and outputs it from the second port to the optical transmission line P10. Furthermore, the wavelength multiplexing/demultiplexing part 6a inputs the downstream optical signal transmitted through the optical transmission line P10 from the second port and demultiplexes the input downstream optical signal into optical signals of different wavelengths. The wavelength multiplexing/demultiplexing part 6a outputs the demultiplexed downstream optical signals from separate first ports to the optical transmission lines P8.

The differences between the third embodiment and the first embodiment described above may be applied to the second embodiment. That is to say, the optical communication system 12 in the second embodiment shown in FIG. 4 may have the optical GW 3a of the third embodiment instead of the optical GW 3.

### Fourth Embodiment

The optical communication system in this embodiment has a plurality of mutually connected optical GWs. This embodiment will be described with a focus on differences from the first embodiment. Note that the difference between the fourth embodiment and the first embodiment may be applied to the second embodiment.

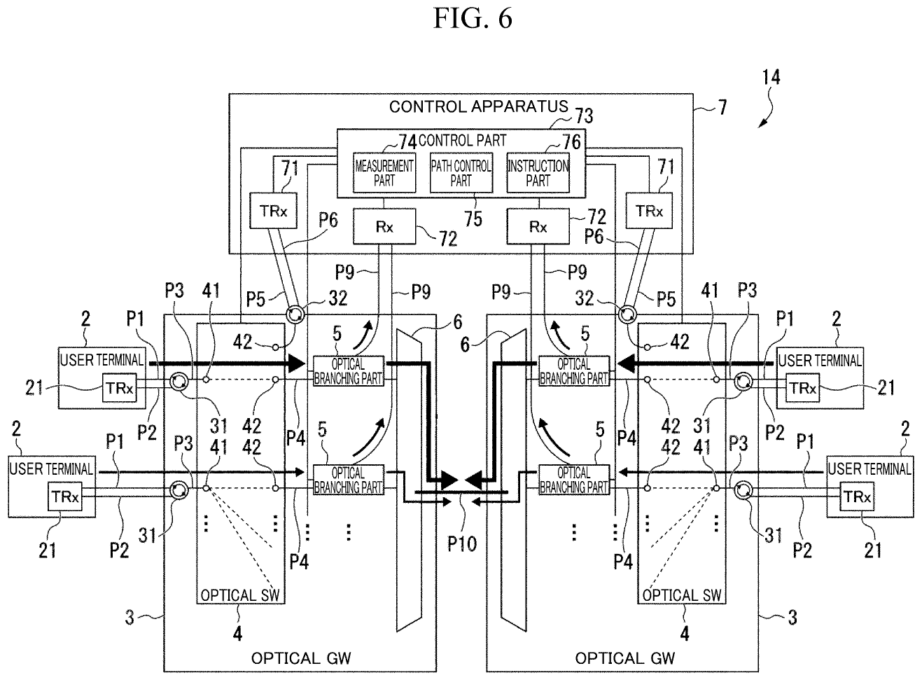

FIG. 6 is a diagram showing the configuration of the optical communication system 14 of the fourth embodiment. Constituent elements in FIG. 6 that are the same as those of the optical communication system 1 according to the first embodiment shown in FIG. 1 are denoted by the same reference numerals and descriptions thereof will be omitted. The optical communication system 14 differs from the optical communication system 1 of the first embodiment in that the optical GW 3 is connected to another optical GW 3 in another link end via an optical transmission line P10. In FIG. 6, the optical communication system 14 has two optical GWs 3, but may have three or more optical GWs 3.

The control apparatus 7 has a plurality of optical transmission/reception parts 71 and a plurality of optical reception parts 72, respectively. Each of the plurality of optical transmission/reception parts 71 is connected to an optical SW 4 of a different optical GW 3. Each of the plurality of optical reception parts 72 is connected to the optical branching part 5 of a different optical GW 3. The path control part 75 of the control apparatus 7 can determine transmission paths between user terminals 2 connected to different optical GWs 3. The path control part 75 determines transmission/reception wavelengths to be assigned to the user terminals 2 and the port connection relationship in the optical SW 4 of each optical GW 3 so that the user terminals 2 transmit and receive optical signals using the determined transmission paths. The path control part 75 notifies each user terminal 2 of the transmission/reception wavelength and instructs the optical SW 4 of each optical GW 3 regarding the port connection relationship, as in the first embodiment. The measurement part 74 and the instruction part 76 of the control apparatus 7 perform the same processing as in the first embodiment on the user terminal 2 connected to each optical GW 3 and the optical branching part 5 of each optical GW 3.

According to this embodiment, even when there is an optical GW on another link end, as in the first to third embodiments, the optical communication system can calculate the transmission distance between the user terminal and the optical GW and set an appropriate branching ratio for the optical branching part on the basis of the calculated transmission distance.

Furthermore, it is possible to maximize the transmission distance by providing an optical branching part in the path on the transmission side and setting the branching ratio in the optical branching part as in the first embodiment.

### Fifth Embodiment

An optical GW in the fourth embodiment has a wavelength multiplexing/demultiplexing part with a single core. The optical GW in this embodiment has a wavelength multiplexing/demultiplexing parts with two cores. This embodiment will be described with a focus on differences from the above-described embodiment.

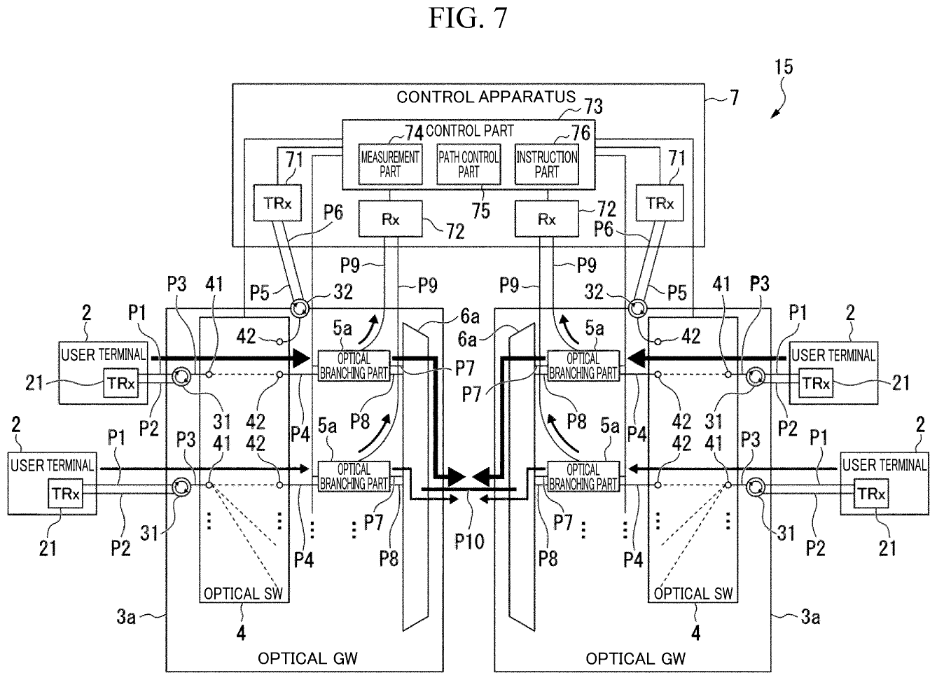

FIG. 7 is a diagram showing a configuration of an optical communication system 15 of the fifth embodiment. Constituent elements in FIG. 7 that are the same as those of the optical communication system 14 according to the fourth embodiment shown in FIG. 6 will be denoted by the same reference numerals and description thereof will be omitted. The optical communication system 15 differs from the optical communication system 14 of the fourth embodiment in that it includes optical GWs 3a of the third embodiment shown in FIG. 5 instead of the optical GWs 3. The plurality of optical transmission/reception parts 71 of the control apparatus 7 are respectively connected to the optical SW 4 of different optical GW 3a and the plurality of optical reception parts 72 are respectively connected to the optical branching parts 5 of different optical GW 3a. The operation of the optical communication system 15 is similar to that of the optical communication system 14 of the fourth embodiment. As described above, the configuration connected to the AWG may be a single-fiber configuration or a two-fiber configuration.

### Sixth Embodiment

In a sixth embodiment, ports of an optical SW are divided into an upstream-only port and a downstream-only port. This embodiment will be described with a focus on differences from the above-described embodiment.

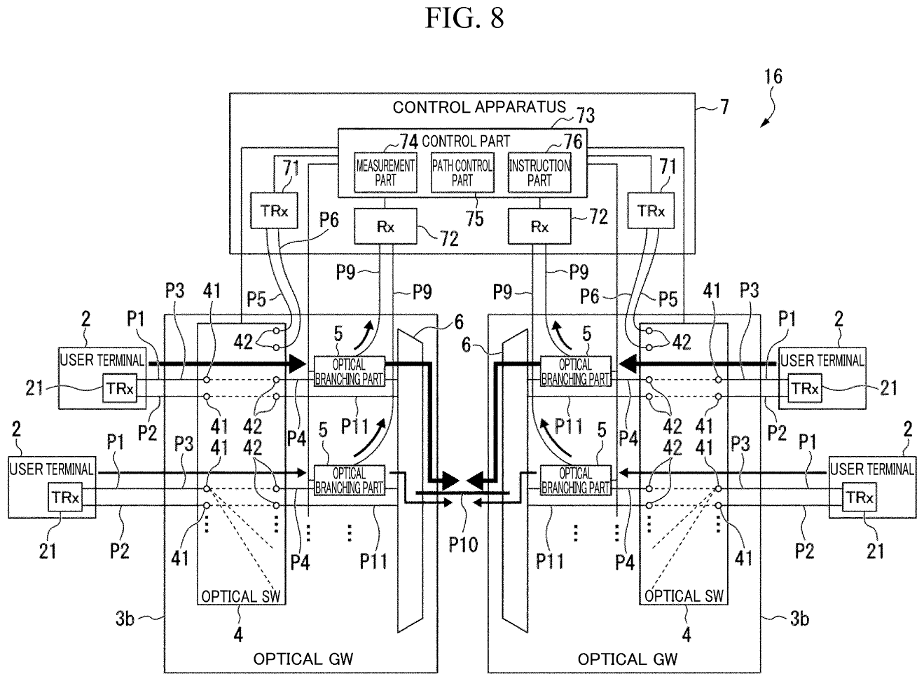

FIG. 8 is a diagram showing a configuration of an optical communication system 16 of the sixth embodiment. Constituent elements in FIG. 8 that are the same as those of the optical communication system 14 according to the fourth embodiment shown in FIG. 6 will be denoted by the same reference numerals and description thereof will be omitted. The optical communication system 16 differs from the optical communication system 14 of the fourth embodiment in that it includes an optical GWs 3b instead of the optical GWs 3.

The optical GW 3b has an optical SW 4, an optical branching part 5 and a wavelength multiplexing/demultiplexing part 6. A plurality of first ports 41 of the optical SW 4 respectively correspond to an upstream or a downstream. The first port 41 corresponding to an upstream is connected to the optical transmission/reception part 21 of the user terminal 2 via the optical transmission line P1 and the first port 41 for a downstream is connected to the optical transmission/reception part 21 of the user terminal 2 via the optical transmission path P2. That is to say, the optical transmission/reception part 21 of the user terminal 2 is connected to the two first ports 41 of the optical SW 4 through the optical transmission line P1 and the optical transmission line P2, respectively. Similarly, a plurality of second ports 42 of the optical SW 4 respectively correspond to an upstream or a downstream. One or more second ports 42 of the second ports 42 corresponding to an upstream are connected to the optical transmission/reception part 71 of the control apparatus 7 via the optical transmission line P6 and the other one or more second ports 42 corresponding to an upstream are connected to the wavelength multiplexing/demultiplexing part 6 via an optical transmission line P4. One or more second ports 42 of the second ports 42 corresponding to a downstream are connected to the optical transmission/reception part 71 of the control apparatus 7 via the optical transmission line P5 and the other one or more second ports 42 corresponding to a downstream are connected to the wavelength multiplexing/demultiplexing part 6 via an optical transmission line P11.

Each of the plurality of first ports (not shown) of the wavelength multiplexing/demultiplexing part 6 corresponds to an upstream or a downstream. The first port corresponding to an upstream of the wavelength multiplexing/demultiplexing part 6 is connected to the second port 42 corresponding to an upstream of the optical SW 4 via the optical transmission line P4 and the first port corresponding to the downstream of the wavelength multiplexing/demultiplexing part 6 is connected to the second port 42 corresponding to the downstream of the optical SW 4 via the optical transmission line P11.

The procedure for setting the branching ratio to the optical branching part 5 in the optical communication system 16 is the same as in the above-described embodiment. Here, the optical communication system 16 performs an upstream communication and a downstream communication as follows.

The optical transmission/reception part 21 of the user terminal 2 outputs an optical signal to the optical transmission line P1. The optical SW 4 outputs, to the second port 42 corresponding to the transmission path to the destination of the optical signal among the second ports 42 corresponding to the upstream signal, the upstream optical signal of a predetermined wavelength in which the first port 41 has input from the optical transmission line P1. That is to say, the optical SW 4 outputs an upstream optical signal to the second setting port 42 connected to the optical transmission/reception part 71 of the control apparatus 7 via the optical transmission line P5 or the second port 42 connected to the wavelength multiplexing/demultiplexing part 6 via the optical transmission line P4. The optical branching part 5 receives the optical signal output from the second port 42 corresponding to the upstream. The optical branching part 5 outputs the optical signal branched from the received upstream optical signal to the optical reception part 72 of the control apparatus 7 and outputs the optical signal not branched to the wavelength multiplexing/demultiplexing part 6. The wavelength multiplexing/demultiplexing part 6 multiplexes the upstream optical signals which are output from the respective second ports 42 corresponding to the upstream of the optical SW 4 and are not branched using the optical branching part 5 and outputs the multiplexed optical signal to the optical transmission line P10.

Also, the wavelength multiplexing/demultiplexing part 6 receives the downstream optical signal transmitted through the optical transmission line P10 and demultiplexes the received downstream optical signal into optical signals of different wavelengths. The wavelength multiplexing/demultiplexing part 6 outputs the demultiplexed downstream optical signals to different optical transmission lines P11. Furthermore, the optical transmission/reception part 71 of the control apparatus 7 outputs a downstream optical signal in which the control management signal of the AMCC signal is set to the optical transmission line P6. The optical SW 4 outputs a downstream optical signal of a predetermined wavelength input from the second port 42 corresponding to the downstream from the first port 41 corresponding to the transmission path to the destination of the optical signal among the first ports 41 corresponding to the downstream to the optical transmission line P2. The optical transmission/reception part 21 of the user terminal 2 receives the optical signal transmitted through the optical transmission line P2.

In the optical SW 4, the first port 41 corresponding to an upstream and the first port 41 corresponding to a downstream may be alternately disposed and the first port 41 corresponding to the upstream and the first port 41 corresponding to the downstream may be disposed separately in an upper position and a lower position. When dividing into the upper position and the lower position, the first port 41 corresponding to upstream may be disposed in the upper position and the first port 41 corresponding to downstream may be disposed in the lower position, or the first port 41 corresponding to downstream may be disposed in the upper position and the first port 41 corresponding to upstream may be disposed in the upper position. Similarly, in the optical SW 4, the second port 42 corresponding to the upstream and the second port 42 corresponding to the downstream may be disposed alternately and the second port 42 corresponding to the upstream and the second port 42 corresponding to the downstream may be disposed separately in an upper position and a lower position. When dividing into the upper position and the lower position, the second port 42 corresponding to upstream may be disposed in the upper position and the second port 42 corresponding to downstream may be disposed in the lower position, or the second port 42 corresponding to downstream may be disposed in the upper position and the second port 42 corresponding to upstream may be disposed in the lower position. Also, the optical SW 4 and the optical branching part 5 may be configured of one PLC.

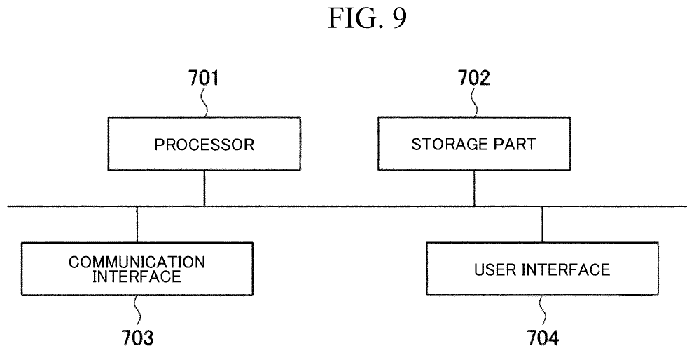

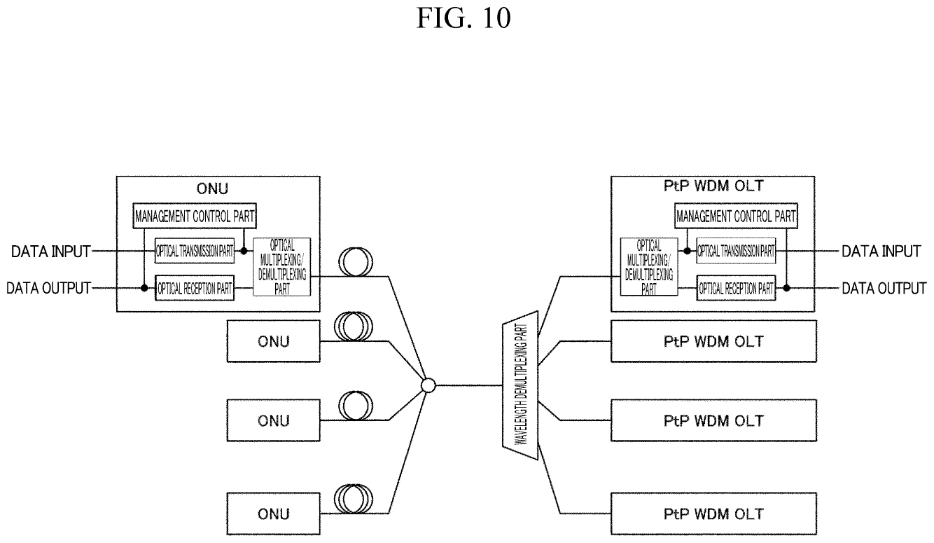

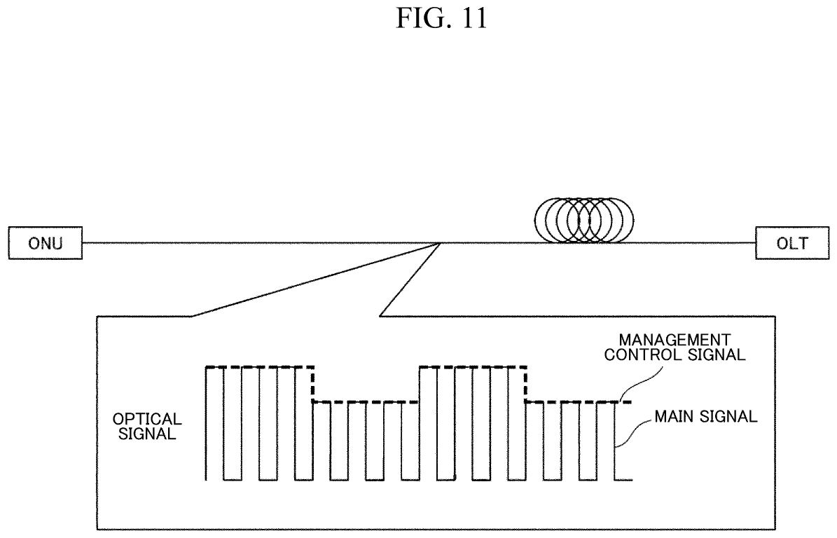

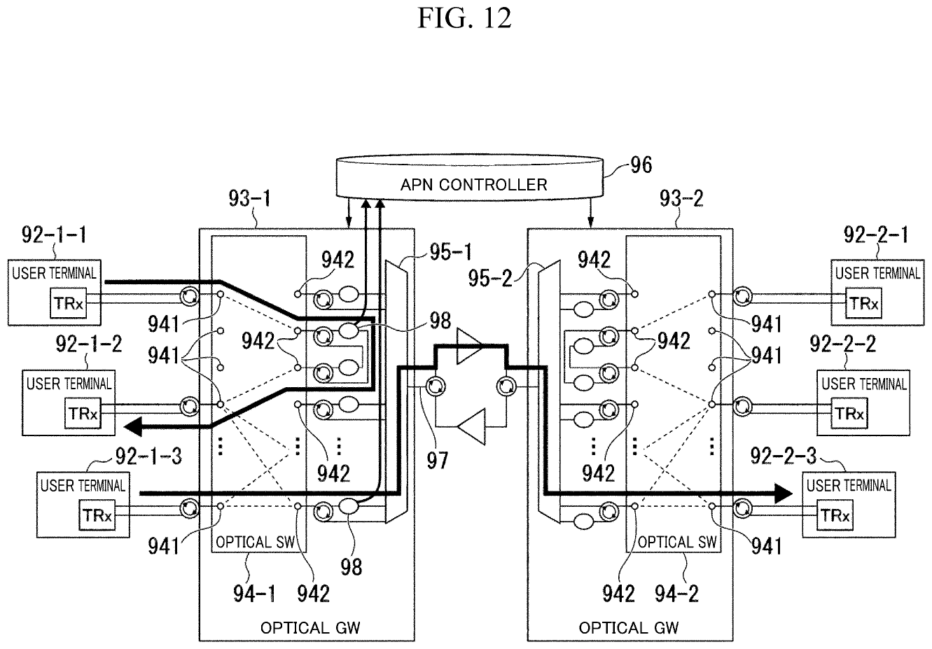

A hardware configuration example of the control apparatus 7 and control apparatus 8 will be described. FIG. 9 is a device configuration diagram showing a hardware configuration example of the control apparatus 7 and control apparatus 8. The control apparatus 7 and control apparatus 8 include a processor 701, a storage part 702, a communication interface 703, and a user interface 704.

The processor 701 is a central processing device which performs calculations and controls. The processor 701 is, for example, a CPU. The processor 701 implements the functions of a control part 73 and a control part 83 by reading the program from the storage part 702 and executing it. The storage part 702 further has a work area and the like used when the processor 701 executes various programs. The communication interface 703 is for communicably connecting to another device. The communication interface 703 is, for example, the optical reception part 72. The user interface 704 is an input device such as a keyboard, a pointing device (mouse, tablet, or the like), buttons, a touch panel and a display device such as a display. The user interface 704 is used for inputting an artificial operation.

Note that all or some of the functions of the control part 73 may be implemented using hardware such as an application specific integrated circuit (ASIC), a programmable logic device (PLD), or a field programmable gate array (FPGA).

According to the embodiment described above, it is possible to change the branching ratio of the optical separation part for extracting the AMCC signal superimposed on the main signal from the optical signal transmitted by the user terminal in accordance with the transmission distance between the user terminal and the optical GW. It is possible to maximize the transmission distance of the main signal by setting the branching ratio of the optical branching part so that the APN controller has the minimum light receiving sensitivity for receiving the AMCC signal.

According to the embodiments described above, the optical communication system has an optical switch, an optical branching part, a measurement part, and an instruction part. An optical switch has a plurality of ports and outputs an optical signal input from a first port that is one of the plurality of ports connected to an optical communication device from a second port that is another one of the plurality of ports according to the transmission path of the optical signal. The optical branching part branches the optical signal which has been output from the second port of the optical switch in accordance with the branching ratio. The measurement part measures the round trip time by transmitting and receiving optical signals to and from the optical communication device via the optical switch and calculates the transmission distance of the optical signal on the basis of the measured round trip time. The instruction part instructs the optical branching part of the branching ratio determined on the basis of the transmission distance measured by the measurement part. For example, the optical GW has an optical switch and an optical branching part, and the control apparatus has a measurement part and an instruction part.

The instruction part may calculate the optical intensity of the optical signal transmitted over the transmission distance calculated by the measurement part and instruct the optical branching part of a branching ratio for branching light of a predetermined light intensity from the light of the calculated light intensity.

Also, the measurement part may measure the optical intensity of the optical signal branched by the optical branching part. In this case, the instruction part instructs the optical branching part to change the branching ratio in accordance with the difference between the measured optical intensity of the optical signal and the predetermined optical intensity so that the light intensity of the optical signal measured by the measurement part approaches a predetermined light intensity.

The predetermined light intensity is an optical intensity which enables the optical receiving part which receives the optical signal branched by the optical branching part to obtain, from the received optical signal, the management control signal which is superimposed on the main signal and is slower than the main signal.

Although the embodiments of the present invention have been described in detail above with reference to the drawings, the specific configuration is not limited to these embodiments and includes designs and the like within the scope of the present invention.

### REFERENCE SIGNS LIST

1, 12, 13, 14, 15, 16 Optical communication system
2, 2-1, 2-2, 92-1-1 to 92-1-3, 92-2-1 to 92-2-3 User terminal
3, 3a, 3b, 93-1, 93-2 Optical GW,
4, 94-1, 94-2 Optical SW
5, 5a Optical branching part
6, 6a, 95-1, 95-2 Wavelength multiplexing/demultiplexing part
7, 8 Control apparatus
21 Optical transmission/reception part
31, 32 Separation part
41, 941 First port
42, 942 Second port
51, 51a, 53 Separation part
52 Optical branching switch
71 Optical transmission/reception part
72 Optical reception part
73, 83 Control part
74, 84 Measurement part
75 Path control part
76, 86 Instruction part
96 APN controller
97 Optical transmission line
98 Splitter
501 Branch ratio variable coupler
511, 513 Fiber
512, 514 Base
551, 552 Waveguide
553 Combiner
554 Power supply
555 Thin film heater
701 Processor
702 Storage part
703 Communication interface
704 User interface
P1, P2, P3, P4, P5, P6, P7, P8, P9, P10, P11 Optical transmission line

1. An optical communication system, comprising:
an optical switch which has a plurality of ports and outputs an optical signal received from a first port that is one of the plurality of ports connected to an optical communication device from a second port that is another one of the plurality of ports according to a transmission path of the optical signal;
an optical branching circuitry which branches the optical signal which has been output from the second port in accordance with a branching ratio;
a measuring controller which measures a round trip time by transmitting and receiving an optical signal to and from the optical communication device through the optical switch and calculates a transmission distance of the optical signal on a basis of the measured round trip time; and
an branch controller which instructs, the optical branching circuitry, of a branching ratio determined on a basis of the calculated transmission distance.

2. An optical communication system, comprising:
an optical switch which has a plurality of ports and outputs an optical signal received from a first port that is one of the plurality of ports connected to an optical communication device from a second port that is another one of the plurality of ports according to a transmission path of the optical signal;
an optical branching circuitry which branches the optical signal which has been output from the second port in accordance with a branching ratio;
a measuring controller which measures an optical intensity of the branched optical signal; and
an branch controller which instructs the optical branching circuitry to change the branching ratio so that the measured optical intensity approaches a predetermined optical intensity.

3. A control apparatus, comprising:
a measuring controller which measures a round trip time by transmitting and receiving optical signals to and from the optical communication device through an optical switch which has a plurality of ports and outputs an optical signal received from a first port that is one of the plurality of ports connected to an optical communication device from a second port that is another one of the plurality of ports according to the transmission path of the optical signal, and calculates a transmission distance of an optical signal on a basis of the measured round trip time; and
an branch controller which instructs, an optical branching circuitry which branches the optical signal which has been output from the second port in accordance with the branching ratio, of the branching ratio determined on a basis of the calculated transmission distance.

4-8. (canceled)
